(19) United States
(12) Patent Application Publication
(10) Pub. No.: US 2024/0316679 A1
(43) Pub. Date: Sep. 26, 2024

(54) BOOM WELDING SYSTEM AND METHOD OF USE

(71) Applicant: Innovatech Systems, LLC, Kanarraville, UT (US)

(72) Inventors: James Barlow, Colorado City, CO (US); James Harker, Colorado City, AZ (US)

(73) Assignee: INNOVATECH SYSTEMS, LLC, Kanarraville, UT (US)

(21) Appl. No.: 18/614,146

(22) Filed: Mar. 22, 2024

Related U.S. Application Data
(60) Provisional application No. 63/491,774, filed on Mar. 23, 2023.

(51) Int. Cl. B23K 9/32

(52) U.S. Cl. CPC B23K 9/32

(57) ABSTRACT

A boom welding system features a boom lift having a boom welding apparatus coupled thereto, the boom welding apparatus having a housing for enclosing a welding machine, a power supply, an air tank, and an air compressor. One or more channels extend along the length of the boom arm and are configured to receive hoses and cables from the housing to the working platform. The boom welding system allows an operator to maintain convenient access to the welding machine and easily stow the lead cable, air hose, and related equipment within the channel and/or housing to eliminate a risk of entanglement while traveling with the boom lift to varying platform elevations and worksites in a building under construction.

### CROSS-REFERENCE TO RELATED APPLICATIONS

This application claims the benefit of U.S. Provisional Application Ser. No. 63/491,774, filed on Mar. 23, 2023, which is incorporated herein by reference.

### TECHNICAL FIELD

The present disclosure relates generally to welding machines. In particular, the present disclosure relates to a welding system mounted to a boom lift and accompanying method of use.

### BACKGROUND

Welding is a fabrication process that joins materials, usually metals or thermoplastics, by using high heat to melt the parts together and allowing them to cool, causing fusion. Arc welding, in particular, uses a welding power supply to create and maintain an electric arc between an electrode and a base material to melt metals at the welding point. Either direct current (DC) or alternating current (AC) can be used in addition to consumable or non-consumable electrodes. The welding region is sometimes protected by some type of inert or semi-inert gas, known as a shielding gas, and filler material is sometimes used as well.

Welding and arc-blasting required at heights typically means running welding cables and air hoses along platforms and machines inside of a building under construction. Such circumstances present scheduling challenges for concurrent and following trades because access to work zones is not available until that portion of the welding scope is complete. Moreover, as welders go from area to area, cables and equipment must be gathered and reset, causing entanglement and safety issues, as well as hurting team efficiency.

Accordingly, there is a need for a welding system that allows equipment to travel with the machine, wherein welding cables and air hoses are channeled to the operator in the lift platform for ease of use, dramatically increasing safety and productivity. The welding system disclosed herein solves these problems and others.

### SUMMARY OF EXAMPLE EMBODIMENTS

In some embodiments, a welding system for boom lifts comprises a housing having one or more apertures, a welding machine (i.e., inverter welder) received within the housing, a pressure gauge, a power supply, an air tank, and an air compressor configured to enable both welding and arc-blasting modalities. Cables and air hoses are routed through the boom lift to a working platform.

In some embodiments, the power supply may comprise a small, portable generator capable of supporting a welding machine having multiple welding processes such as Stick, TIG, pulsed and CV MIG, as well as arc gouging. The welding machine may be configured to support multiple input voltages, without limitation, from 200V up to 600V, single phase, or 3-phase.

### BRIEF DESCRIPTION OF THE DRAWINGS

FIG. 1 illustrates a front side perspective view of a boom welding apparatus;

FIG. 2 illustrates a side perspective view of a boom welding apparatus;

FIG. 3 illustrates a rear perspective view of a boom welding apparatus;

FIG. 4 illustrates a front, side transparent perspective view of a boom welding apparatus;

FIG. 5 illustrates a front right side perspective view of a boom welding apparatus with a first door of the housing closed;

FIG. 6 illustrates a front elevation view of a boom welding apparatus coupled to a boom lift;

FIG. 7 illustrates a right side perspective view of a boom welding apparatus with a first door of the housing open;

FIG. 8 illustrates a left side perspective view a boom welding apparatus with a second door of the housing open;

FIG. 9 illustrates a side perspective view of a boom welding system;

FIG. 10 illustrates a side perspective view of a boom welding system with a working platform extended;

FIG. 11 illustrates a detailed, front perspective view of channels with cables and hoses of a boom welding system; and

FIG. 12 illustrates a perspective view of channels with cables and hoses of a boom welding system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a welding system that allows equipment to travel with a lift platform or other machine, wherein welding cables and air hoses are channeled to the operator for ease of use. The boom welding apparatus and system disclosed herein mitigates the risk of entanglement and dramatically increases safety and productivity, solving needs in the industry.

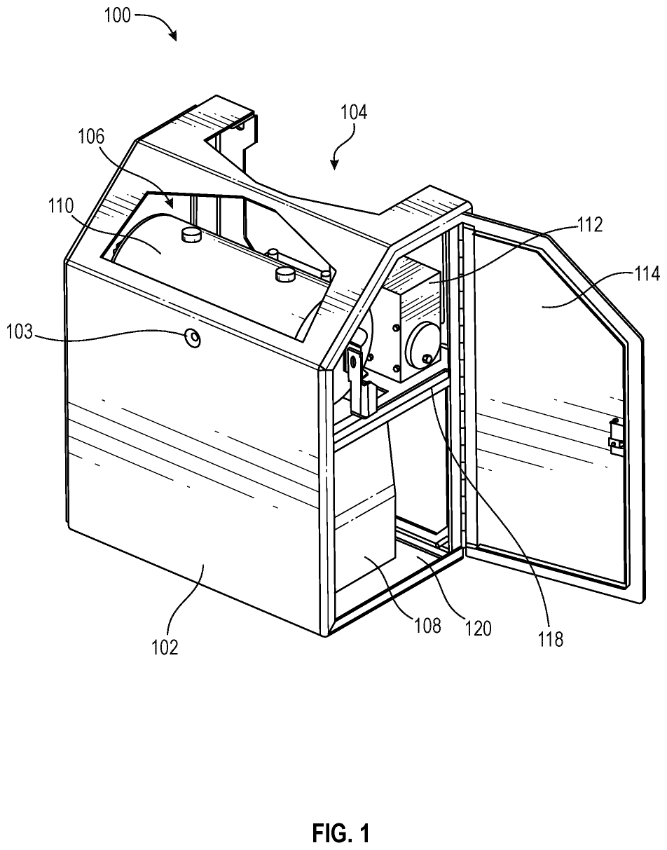

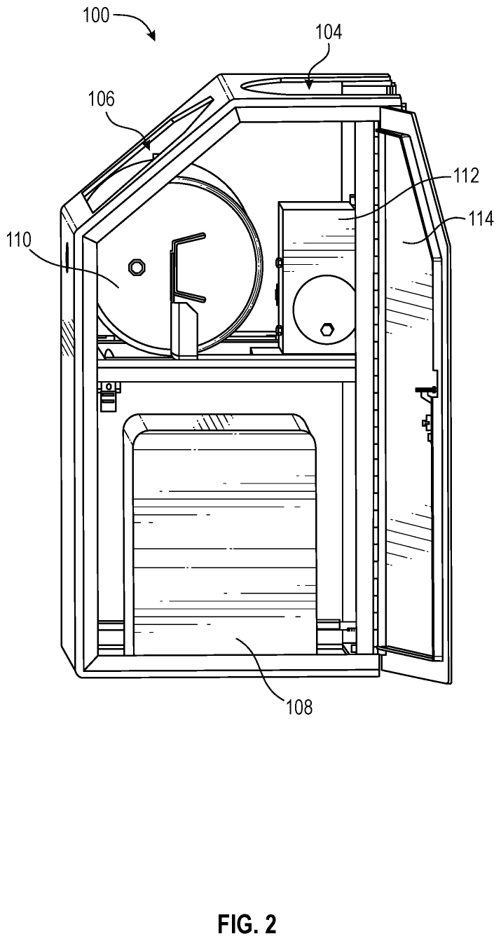

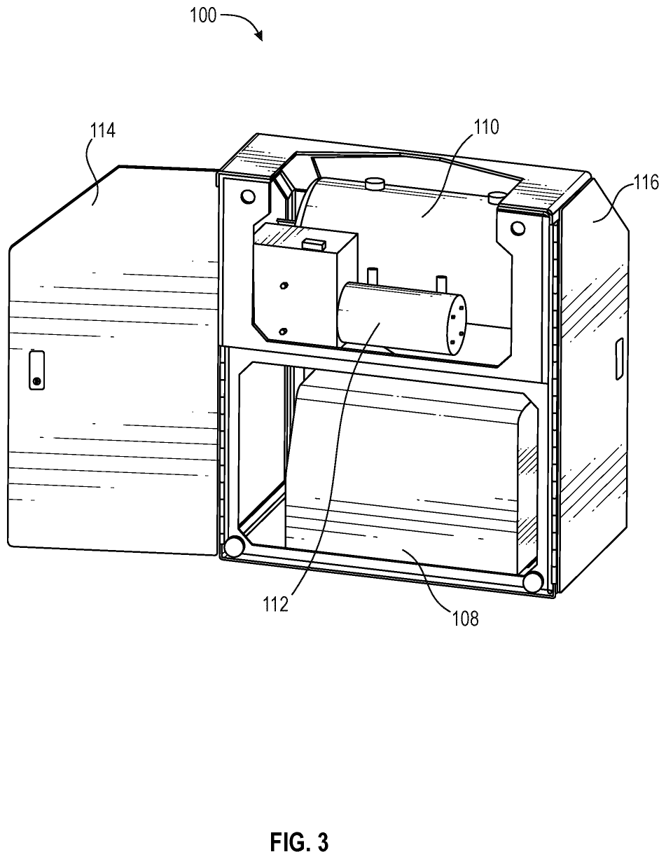

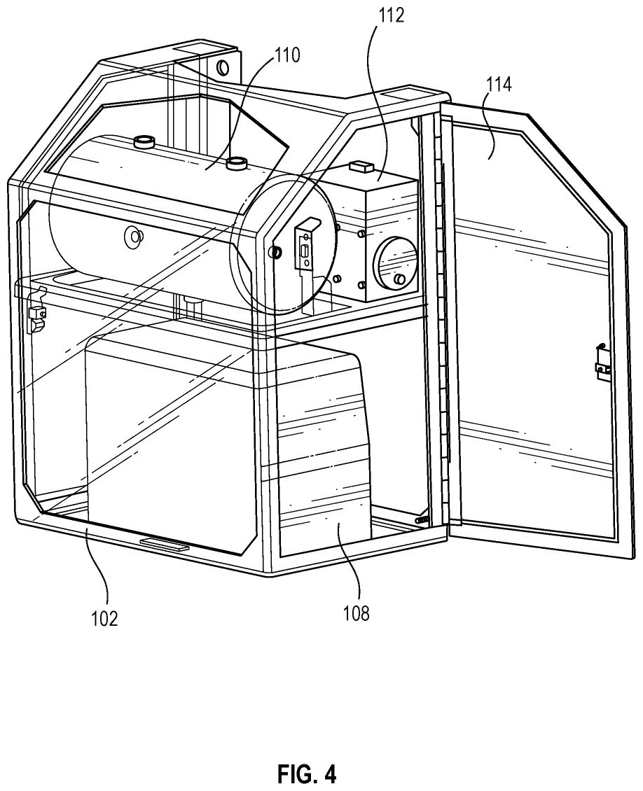

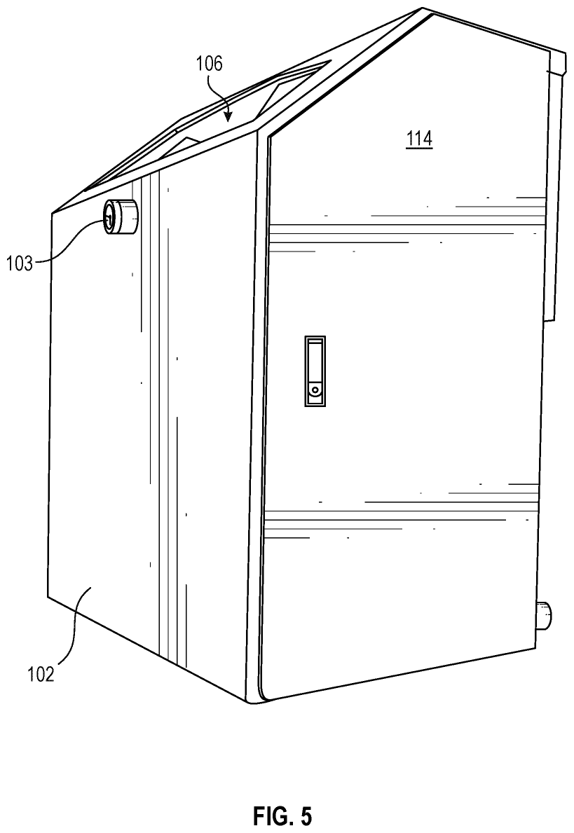

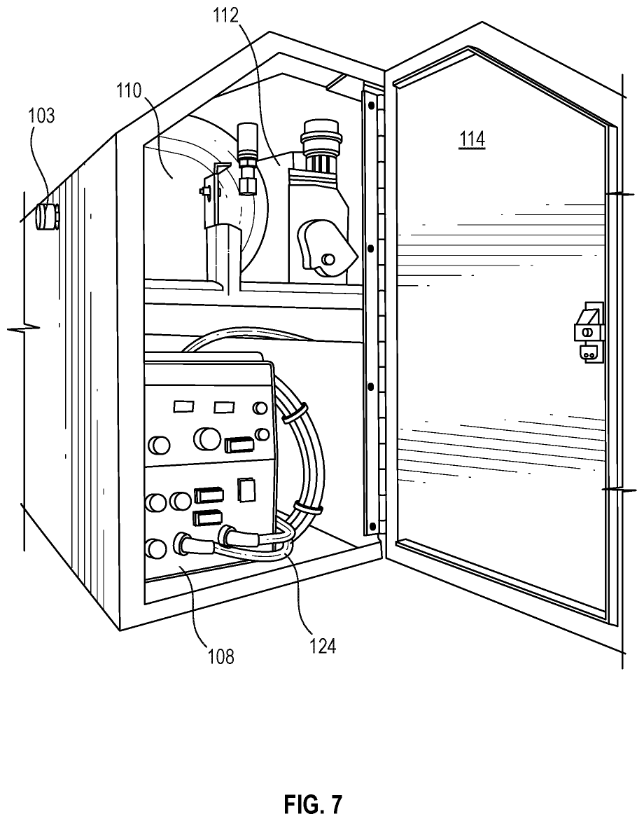

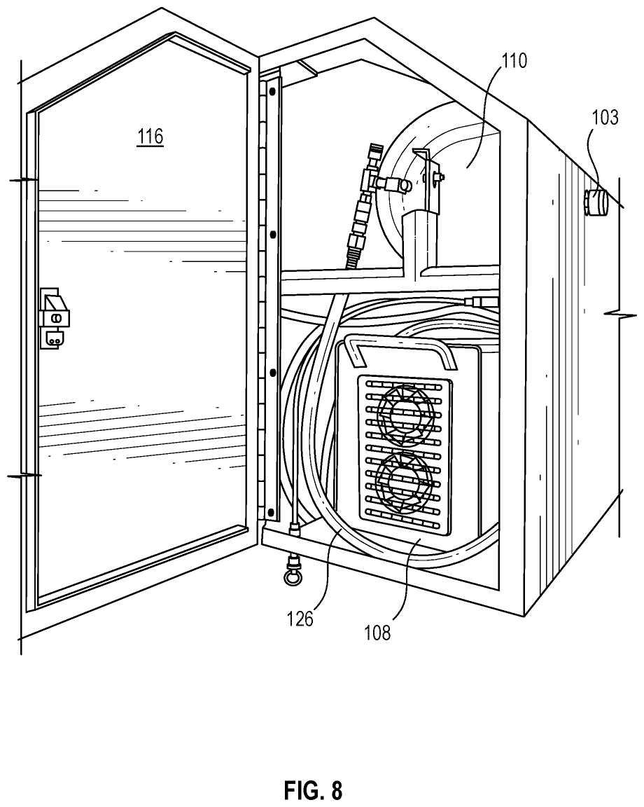

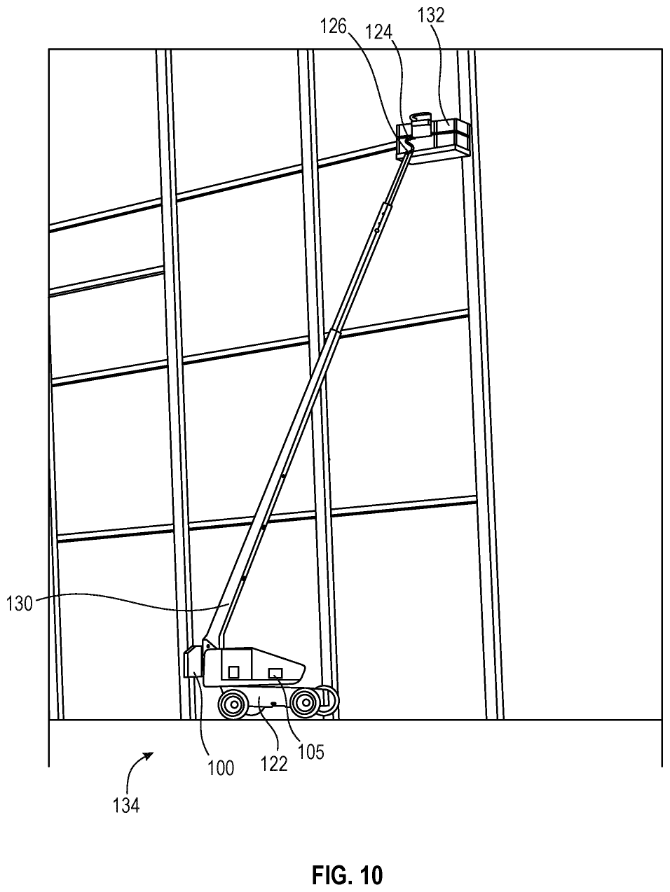

In some embodiments, as shown in FIGS. 1-8, a boom welding apparatus 100 comprises a housing 102 having one or more apertures 104, 106, a welding machine (i.e., inverter welder) 108 couplable within the housing 102, a pressure gauge 103, a power supply (e.g., generator 105 (which may be mounted on, or in, the boom lift as shown in FIG. 10), boom engine, battery bank, etc.), an air tank 110, and an air compressor 112 configured to enable both welding and arc-blasting modalities. A hook, latch, threaded fastener, integral fastener, or alternative fastening mechanism may be couplable between the housing 102 and a boom lift or other machine. The power supply may comprise a small, portable generator capable of supporting a welding machine 108 configured for multiple welding processes such as Stick, TIG, pulsed and CV MIG, as well as arc gouging. The welding machine 108 may be configured to support multiple input voltages, without limitation, from 200V up to 600V, single phase, or 3-phase. The welding machine 108 may comprise a lead cable fed through the one or more apertures 104, 106 when the operator is using an electrode for welding.

In some embodiments, the housing 102 may further comprise a first door 114 on a first side and a second door 116 on a second side, opposite the first side. The first and second doors 114, 116 enable convenient access by the user to position, adjust, or otherwise perform maintenance on internal components (e.g., welding machine 108, air tank 110, air compressor 112) within the housing 102. Moreover, the lead cable may be channeled through either the first or second doors 114, 116, respectively, for additional access by the operator.

As depicted, though without limitation, the housing 102 may comprise an upper shelf 118 wherein the air compressor 112 and the air tank 110 are positioned, and a lower shelf 120 wherein the welding machine 108 is located. In some embodiments, the boom welding apparatus 100 may comprise a retractable hose reel or other coiling and wrapping machine configured to manually or automatically dispense and retract the lead cable or air hose during operation of the welding machine 108. For example, the retractable hose reel may be motor driven or self-winding, wherein the lead cable and/or air hose retract into the housing 102 for storage after use.

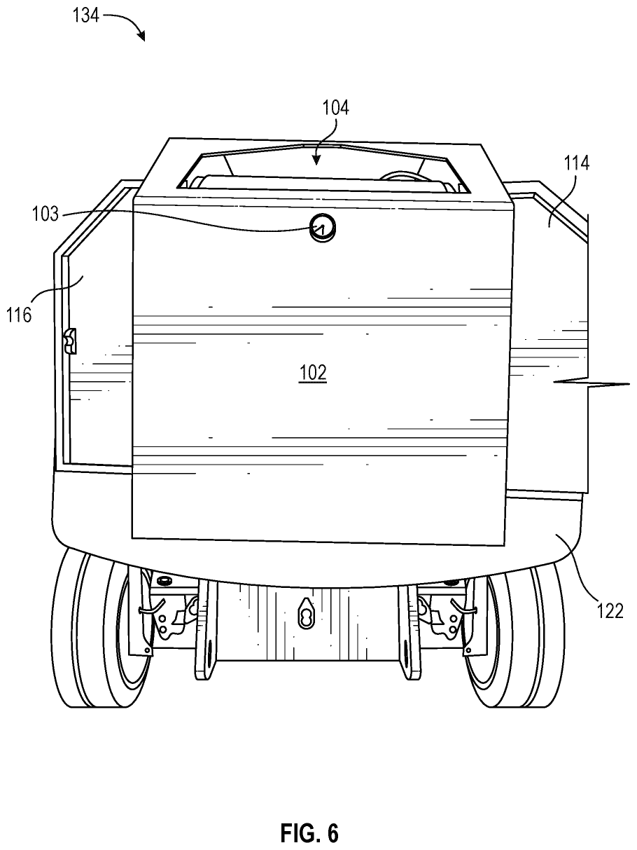

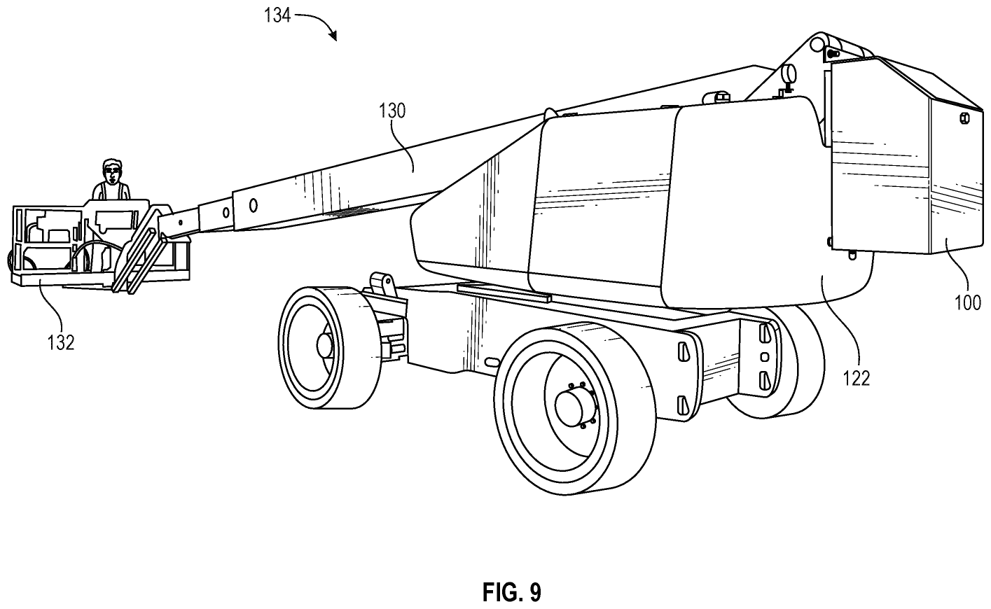

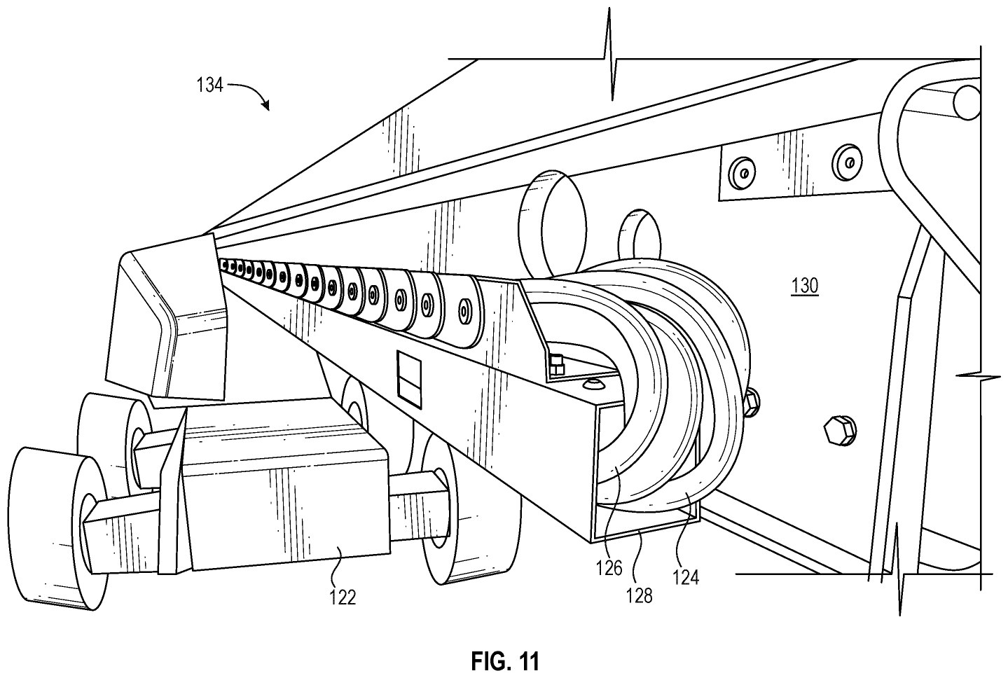

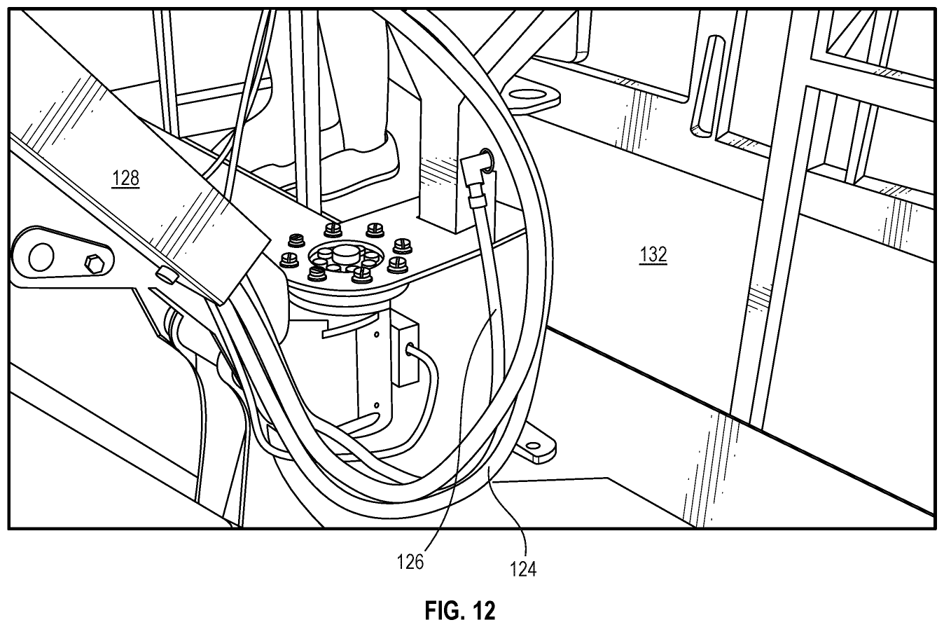

Referring to FIGS. 6 and 9-12, it will be appreciated that the boom welding apparatus 100 may be mounted to on a boom lift 122 (e.g., Snorkel boom lift), allowing the welding machine 100 to travel with the boom lift 122 to varying worksites in a building under construction, and to allow a user to weld at various platform elevations with ease. To accomplish this, and as best shown in FIG. 11, cables 124 and hoses 126 are routed in one or more channels 128 along the length of the boom arm 130. As shown in FIG. 12, the cables 124 and hoses 126 exit the channel 128 near the working platform 132 for use by the user. Accordingly, the operator maintains convenient access to the welding components at any height and may easily stow the lead cable, air hoses, and related equipment within the channels 128 and housing 102, respectively, to eliminate a risk of entanglement.

Accordingly, in some embodiments, a boom welding system 134 comprises a boom welding apparatus 100 coupled to a boom lift 122, the boom welding apparatus 100 comprising a housing 102 having welding components (e.g., welding machine 108, air tank 110, air compressor 112, etc.) therein. Cables 124 and hoses 126 may run from the respective various welding components in the housing 102, through one or more channels 128 along the boom arm 130 (or arm assembly), and be available at the working platform 132. It will be appreciated that the cables 124 and hoses 126 are configured to extend and retract in conjunction with the boom arm 130. As a result, the cables 124 and hoses 126 are ready for use at any height and do not become entangled or create a hazard for others. In addition to increasing safety, efficiency is also increased. In other words, a user in the working platform 132 may easily navigate the boom 122 and the working platform 132 to the desired location and begin welding without ever needing to leave the working platform 132. It will be appreciated that excess cable 124 and hosing 126 may be stored along the boom arm 130 in the one or more channels 128 or may also be stored on a spool within the housing 102, or both.

Accordingly, the boom welding apparatus and system disclosed herein solves the need for a welding system that allows equipment to travel with a lift platform or other machine, wherein welding cables and air hoses are channeled to the operator for ease of use. The boom welding apparatus and system disclosed herein mitigates the risk of entanglement and dramatically increases safety and productivity, solving needs in the industry.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A boom welding system, comprising:
a boom welding apparatus configured to couple to a boom lift, the boom welding apparatus comprising:
a housing configured to receive and store a welding machine, an air compressor, and an air tank;
one or more channels extending along a length of a boom arm;
one or more hoses and one or more cables extending from the boom welding apparatus, through the one or more channels along the length of the boom arm, and to a working platform.

2. The boom welding system of claim 1, wherein the housing comprises one or more apertures.

3. The boom welding system of claim 1, wherein the housing further comprises at least one door.

4. The boom welding system of claim 1, wherein the housing further comprises a pressure gauge.

5. A boom welding system, comprising:
a boom lift;
a boom welding apparatus coupled to the boom lift, the boom welding apparatus comprising:
a housing configured to receive and store a welding machine, an air compressor, and an air tank, the housing comprising a least one door to provide access to its interior and at least one shelf therein;
one or more channels extending along a length of a boom arm;
one or more hoses and one or more cables extending from the boom welding apparatus, through the one or more channels along the length of the boom arm, and to a working platform; and
at least one gauge.

6. A method of using a boom welding system, the method comprising:
navigating a boom lift to a desired location;
extending a working platform, via a boom arm, to a desired height; and
commencing welding;
wherein the boom lift comprises a boom welding apparatus coupled thereto with one or more cables and one or more hoses extending to the working platform through one or more channels along a length of the boom arm.
